(19) United States
(12) Patent Application Publication
(10) Pub. No.: US 2013/0169161 A1
(43) Pub. Date: Jul. 4, 2013

(54) Cold Cathode Fluorescent Lamp Illumination Device with Protection Mechanism

(71) Applicant: Pau-Sheng Huang, Miaoli County (TW)

(72) Inventor: Pau-Sheng Huang, Miaoli County (TW)

(73) Assignee: WEI POWER TECHNOLOGY CO., LTD., Taoyuan County (TW)

(21) Appl. No.: 13/450,448

(22) Filed: Apr. 18, 2012

(30) Foreign Application Priority Data
Dec. 30, 2011 (TW) 100225059

(51) Int. Cl. H05B 41/36

(52) U.S. Cl. 315/127

(57) ABSTRACT

An illumination device includes a transformer, a protection circuit, and a cold cathode fluorescent lamp (CCFL) tube. The transformer is for converting a first alternating current power to a second alternating current power. The protection circuit includes a relay and an over-voltage detecting circuit. The relay is coupled to a first end of the transformer, and the relay includes a contact pin, the contact pin is electrically connected to the first end when the relay is turned off, and the contact pin is electrically disconnected from the first end when the relay is turned on. The over-voltage detecting circuit is for turning on the relay when the second alternating current power is over a predetermined value, and for turning off the relay when the second alternating current power is below the predetermined value. The CCFL tube is electrically connected between the contact pin and a second end of the transformer.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a cold cathode fluorescent lamp illumination device, and more particularly, to a cold cathode fluorescent lamp illumination device with protection mechanism.

2. Description of Related Arts

Cold Cathode Fluorescent Lamp (CCFL) has advantages of long life, energy saving, high brightness, small size, etc. Therefore, the CCFL is gradually utilized for home illumination. Please refer to FIG. 1, FIG. 1 is a diagram showing a CCFL illumination device disclosed by U.S. Patent No. US 20060273731. As shown in FIG. 1, a lamp shell accommodates a transformer and a CCFL tube inside, where the transformer converts an alternating current power provided from an electronic ballast to another alternating current power for driving the CCFL tube. In order to protect CCFL tube from a spark voltage generated by the transformer, U.S. Patent No. US 20060273731 teaches to couple a capacitor (or a fuse) with a primary winding of the transformer in parallel for shorting the capacitor when a voltage level of the primary winding of the transformer is over a predetermined value, so as to protect the CCFL tube from the spark voltage.

However, the capacitor or the fuse can only withstand a certain voltage level, if the voltage level of the primary winding of the transformer is too high such that the capacitor or the fuse is damaged, the CCFL tube no longer has protection mechanism. Therefore, the protection mechanism of the CCFL illumination device of the prior art can not be reused for multiple times.

### SUMMARY OF THE PRESENT INVENTION

The present invention provides a cold cathode fluorescent lamp illumination device with protection mechanism. The cold cathode fluorescent lamp illumination device comprises a transformer, a protection circuit, a cold cathode fluorescent lamp (CCFL) tube, and a lamp shell. The transformer is for converting a first alternating current power provided by an electronic ballast to a second alternating current power. The protection circuit is electrically connected to the transformer. The protection circuit comprises a relay and an over-voltage detecting circuit. The relay is coupled to a first end of the transformer, and the relay comprises a contact pin, the contact pin is electrically connected to the first end when the relay is turned off, and the contact pin is electrically disconnected from the first end when the relay is turned on. The over-voltage detecting circuit is for turning on the relay when the second alternating current power is over a predetermined value, and for turning off the relay when the second alternating current power is below the predetermined value. A first end of the cold cathode fluorescent lamp tube is electrically connected to the contact pin of the relay, and a second end of the cold cathode fluorescent lamp tube is electrically connected to a second end of the transformer. The lamp shell is for accommodating the transformer, the protection circuit and the CCFL tube.

The present invention further provides another cold cathode fluorescent lamp illumination device with protection mechanism. The cold cathode fluorescent lamp illumination device comprises a transformer, a protection circuit, a CCFL tube, and a lamp shell. The transformer is for converting a first alternating current power provided by an electronic ballast to a second alternating current power. The protection circuit is electrically connected to the transformer. The protection circuit comprises a half-wave control circuit, and an over-voltage detecting circuit. A first end of the half-wave control circuit is electrically connected to a first end of the transformer. The half-wave control circuit is for allowing current flowing from a second end to the first end of the half-wave control circuit when the half-wave control circuit is turned on, and for disconnecting the first end from the second end of the half-wave control circuit when the half-wave control circuit is turned off. The over-voltage detecting circuit is electrically connected to the transformer and the half-wave control circuit for turning on the half-wave control circuit when the second alternating current power is over a predetermined value, and for turning off the half-wave control circuit when the second alternating current power is below the predetermined value. A first end of the CCFL tube is electrically connected to the second end of the half-wave control circuit, and a second end of the CCFL tube is electrically connected to a second end of the transformer. The lamp shell is for accommodating the transformer, the protection circuit and the CCFL tube.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a cold cathode fluorescent lamp illumination device of the prior art.

FIG. 2 is a functional block diagram of a cold cathode fluorescent lamp illumination device of the present invention.

FIG. 3 is a diagram showing a circuit of the cold cathode fluorescent lamp illumination device in FIG. 2.

FIG. 4 is a diagram showing another cold cathode fluorescent lamp illumination device of the present invention.

### DETAILED DESCRIPTION OF THE PREFERRED EMBODIMENT

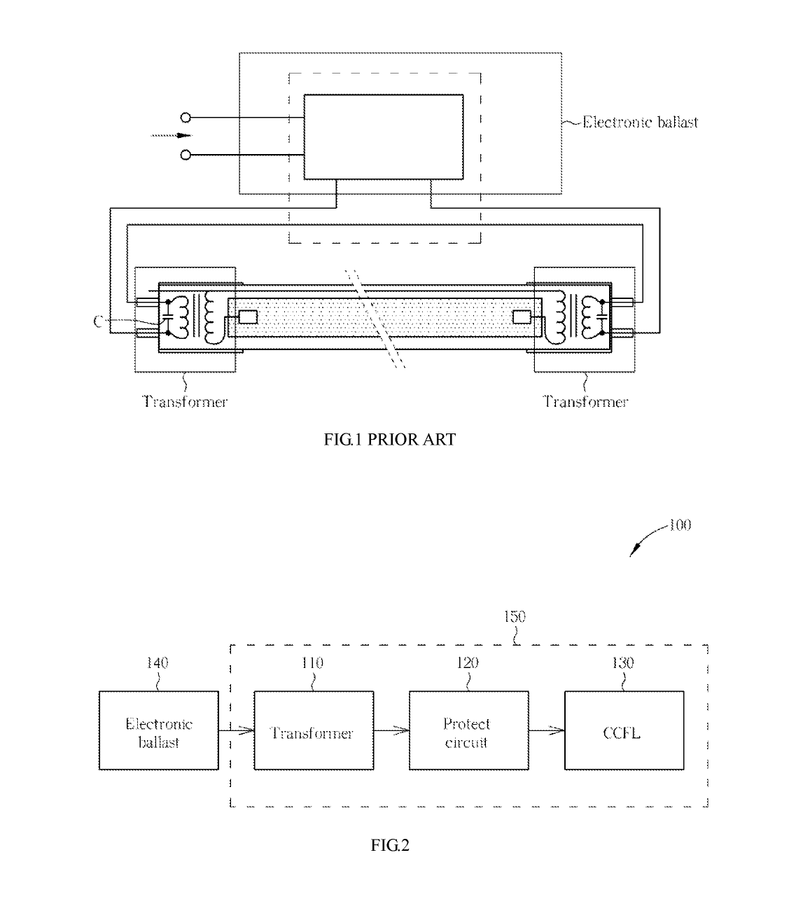

Please refer to FIG. 2, FIG. 2 is a functional block diagram of a cold cathode fluorescent lamp illumination device of the present invention. As shown in FIG. 2, the cold cathode fluorescent lamp illumination device 100 of the present invention comprises a transformer 110, a protection circuit 120, a cold cathode fluorescent lamp (CCFL) tube 130, and a lamp shell 150. The transformer 110 is electrically connected to an electronic ballast 140 for converting a first alternating current power provided by the electronic ballast 140 to a second alternating current power. The CCFL tube 130 is electrically connected to the transformer 110 via the protection circuit 120 for emitting light according to the second alternating current power generated by the transformer 110. The protection circuit 120 is electrically connected between the transformer 110 and the CCFL tube 130 for providing protection mechanism when the second alternating current power generated by the transformer 110 is over a predetermined value. The lamp shell 150 is for accommodating the transformer 110, the protection circuit 120, and the CCFL tube 130.

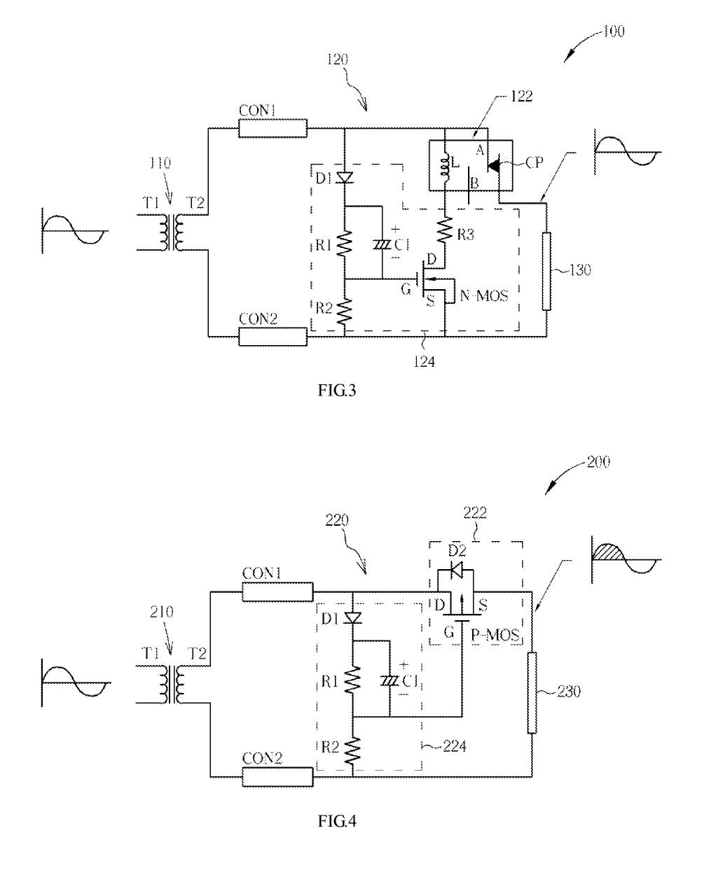

Please refer to FIG. 3, and refer to FIG. 2 as well. FIG. 3 is a diagram showing a circuit of the cold cathode fluorescent lamp illumination device in FIG. 2. As shown in FIG. 3, a primary winding T1 of the transformer 110 is electrically connected to the electronic ballast 140 for receiving a first alternating current power provided by the electronic ballast 140, and a secondary winding T2 of the transformer 110 is for generating a second alternating current power according to the first alternating current power. The protection circuit 120 comprises a relay 122 and an over-voltage detecting circuit 124. The relay 122 is electrically connected to a first end CON1 of the secondary winding T2 of the transformer 110. The relay comprises a contact pin CP and an electromagnetic element L. When the relay 122 is turned off, the electromagnetic element L is not electrically conducted, such that the contact pin CP is located at a first position A for being electrically connected to the first end CON1 of the secondary winding T2 of the transformer 110. When the relay 122 is turned on, the electromagnetic element L is electrically conducted, such that the contact pin CP is located at a second position B for being electrically disconnected from the first end CON1 of the secondary winding T2 of the transformer 110. The over-voltage detecting circuit 124 comprises a diode D1, a first resistor R1, a second resistor R2, a capacitor C1, and a N-type thyristor N-MOS. A positive end of the diode D1 is electrically connected to the first end CON1 of the secondary winding T2 of the transformer 110. A first end of the first resistor R1 is electrically connected to a negative end of the diode D1. A first end of the second resistor R2 is electrically connected to a second end of the first resistor R1, and a second end of the second resistor R2 is electrically connected to a second end CON2 of the secondary winding T2 of the transformer 110. A first end of the capacitor C1 is electrically connected to the first end of the first resistor R1, and a second end of the capacitor C1 is electrically connected the second end of the first resistor R1. A drain end D of the N-type thyristor N-MOS is electrically connected to the electromagnetic element L of the relay 122. A source end S of the N-type thyristor N-MOS is electrically connected to the second end CON2 of the secondary winding T2 of the transformer 110. A gate end G of the N-type thyristor N-MOS is electrically connected to the second end of the capacitor C1. A first end of the CCFL tube 130 is electrically connected to the contact pin CP of the relay 122, and a second end of the CCFL tube 130 is electrically connected to the second end CON2 of the secondary winding T2 of the transformer 110.

When the second alternating current power generated by the secondary winding T2 of the transformer 110 is over a predetermined value, the capacitor C1 becomes short to increase a voltage level at the gate end G of the N-type thyristor N-MOS, such that the drain end D and the source end S of the N-type thyristor N-MOS are conducted to turn on the relay 122, and the contact pin CP is moved to the second position B from the first position A. Therefore, the CCFL tube 130 does not receive the second alternating current power. When the second alternating current power is below the predetermined value, the capacitor C1 is no longer short, and the voltage level at the gate end G of the N-type thyristor N-MOS becomes lower, such that the drain end D and the source end S of the N-type thyristor N-MOS are not conducted to turn off the relay 122, and the contact pin CP is moved back to the first position A from the second position B. Therefore, the CCFL tube 130 receives the second alternating current power again and emits light. According to the above arrangement, the CCFL tube 130 will not be damaged by the spark voltage, and the capacitor C1 is protected by the N-type thyristor N-MOS and the second resistor R2, where the N-type thyristor N-MOS allows part of the current to pass through and the second resistor R2 limits the current flowing through the capacitor C1.

Please referring to FIG. 4, FIG. 4 is a diagram showing another cold cathode fluorescent lamp illumination device of the present invention. As shown in FIG. 4, a primary winding T1 of the transformer 210 is electrically connected to the electronic ballast 140 for receiving a first alternating current power provided from the electronic ballast 140, and a secondary winding T2 of the transformer 210 is for generating a second alternating current power according to the first alternating current power. A protection circuit 220 comprises a half-wave control circuit 222, and an over-voltage detecting circuit 224. The half-wave control circuit 222 comprises a diode D2, and a P-type thyristor P-MOS. A negative end of the diode D2 is electrically connected to the first end CON1 of the secondary winding T2 of the transformer 210, and a positive end of the diode D2 is electrically connected to the first end of the CCFL tube 230. A source end S of the P-type thyristor P-MOS is electrically connected to the positive end of the diode D2. A drain end D of the P-type thyristor P-MOS is electrically connected to the negative end of the diode D2. A gate end G of the P-type thyristor P-MOS is electrically connected to the over-voltage detecting circuit 224. The half-wave control circuit 222 is utilized for allowing current flowing from the source end S to the drain end D of the P-type thyristor P-MOS when the P-type thyristor P-MOS is turned on. The diode D2 also restricts a flowing direction of the current, such that the CCFL tube 230 only receives half waves of the second alternating current power. When the P-type thyristor P-MOS is turned off, the source end S is disconnected from the drain end D, such that the CCFL tube 230 does not receive the second alternating current power. The over-voltage detecting circuit 224 comprises a diode D1, a first resistor R1, a second resistor R2, and a capacitor C1. A positive end of the diode D1 is electrically connected to the first end CON1 of the secondary winding T2 of the transformer 210. A first end of the first resistor R1 is electrically connected to a negative end of the diode D1. A first end of the second resistor R2 is electrically connected to a second end of the first resistor R1, and a second end of the second resistor R2 is electrically connected to the second end CON2 of the secondary winding T2 of the transformer 210. A first end of the capacitor C1 is electrically connected to the first end of the first resistor R1, and a second end of the capacitor C1 is electrically connected to the second end of the first resistor R1 and the gate end G of the P-type thyristor P-MOS.

When the second alternating current power generated by the secondary winding T2 of the transformer 210 is over a predetermined value, the capacitor C1 becomes short to increase a voltage level at the gate end G of the P-type thyristor P-MOS for turning off the P-type thyristor P-MOS, such that the drain end D is disconnected from the source end S of the P-type thyristor P-MOS. Therefore, the CCFL tube 230 does not receive the second alternating current power. When the second alternating current power is below the predetermined value, the capacitor C1 is no longer short and the voltage level at the gate end G of the P-type thyristor P-MOS becomes lower for turning on the P-type thyristor P-MOS, such that the drain end D and the source end S of the P-type thyristor P-MOS are conducted. Therefore, the CCFL tube 230 receives half waves of the second alternating current power again and emits light. According to the above arrangement, the CCFL tube 230 will not be damaged by the spark voltage, and the capacitor C1 is protected by the second resistor R2, where the second resistor R2 limits the current flowing through the capacitor C1.

In contrast to the prior art, the protection circuit of the CCFL illumination device of the present invention is capable of activating the protection mechanism according to the voltage level at the secondary winding of the transformer, in order to protect the CCFL tube from being damaged by the spark voltage. In addition, the protection circuit of the present invention can be reused for multiple times.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cold cathode fluorescent lamp illumination device with protection mechanism, comprising:
a transformer, for converting a first alternating current power provided by an electronic ballast to a second alternating current power;
a protection circuit, electrically connected to the transformer, the protection circuit comprising:
a relay, electrically connected to a first end of the transformer, the relay comprising a contact pin, when the relay is turned off, the contact pin is electrically connected to the first end of the transformer, when the relay is turned on, the contact pin is electrically disconnected from the first end of the transformer; and
an over-voltage detecting circuit, electrically connected to the transformer and the relay for turning on the replay when the second alternating current power is over a predetermined value, and for turning off the replay when the second alternating current power is below the predetermined value;
a cold cathode fluorescent lamp (CCFL) tube, a first end of the cold cathode fluorescent lamp tube being electrically connected to the contact pin of the relay, a second end of the cold cathode fluorescent lamp tube being electrically connected to a second end of the transformer; and
a lamp shell, for accommodating the transformer, the protection circuit and the cold cathode fluorescent lamp tube.

2. The illumination device of claim 1, wherein the over-voltage detecting circuit comprising:
a diode, with a positive end electrically connected to the first end of the transformer;
a first resistor, with a first end electrically connected to a negative end of the diode;
a second resistor, with a first end electrically connected to a second end of the first resistor, and a second end electrically connected to the second end of the transformer;
a capacitor, with a first end electrically connected to the first end of the first resistor, and a second end electrically connected a second end of the first resistor; and
a N-type thyristor, with a drain end electrically connected to the relay, a source end electrically connected to the second end of the transformer, and a gate end electrically connected to the second end of the capacitor;
wherein when the second alternating current power is over the predetermined value, the drain end and the source end of the N-type thyristor are conducted to turn on the relay; and when the second alternating current power is below the predetermined value, the drain end and the source end of the N-type thyristor are not conducted to turn off the relay.

3. The illumination device of claim 1, wherein the relay further comprising an electromagnetic element for moving the contact pin to disconnect the contact pin from the first end of the transformer when the relay is turned on.

4. A cold cathode fluorescent lamp illumination device with protection mechanism, comprising:
a transformer, for converting a first alternating current power provided by an electronic ballast to a second alternating current power;
a protection circuit, electrically connected to the transformer, the protection circuit comprising:
a half-wave control circuit, a first end of the half-wave control circuit being electrically connected to a first end of the transformer, the half-wave control circuit being for allowing current flowing from a second end to the first end of the half-wave control circuit when the half-wave control circuit is turned on, and for disconnecting the first end from the second end of the half-wave control circuit when the half-wave control circuit is turned off; and
an over-voltage detecting circuit, electrically connected to the transformer and the half-wave control circuit for turning on the half-wave control circuit when the second alternating current power is over a predetermined value, and for turning off the half-wave control circuit when the second alternating current power is below the predetermined value;
a cold cathode fluorescent lamp (CCFL) tube, a first end of the cold cathode fluorescent lamp tube being electrically connected to the second end of the half-wave control circuit, a second end of the cold cathode fluorescent lamp tube being electrically connected to a second end of the transformer; and
a lamp shell, for accommodating the transformer, the protection circuit and the cold cathode fluorescent lamp tube.

5. The illumination device of claim 4, wherein the half-wave control circuit comprising:
a first diode, with a negative end electrically connected to the first end of the transformer, and a positive end electrically connected to the first end of the cold cathode fluorescent lamp tube; and
a P-type thyristor, with a source end electrically connected to the positive end of the first diode, a drain end electrically connected to the negative end of the first diode, and a gate end electrically connected to the over-voltage detecting circuit.

6. The illumination device of claim 5, wherein the over-voltage detecting circuit comprising:
a second diode, with a positive end of the diode electrically connected to the first end of the transformer;
a first resistor, with a first end electrically connected to a negative end of the second diode;
a second resistor, with a first end electrically connected to a second end of the first resistor, and a second end electrically connected to the second end of the transformer;
a capacitor, with a first end electrically connected to the first end of the first resistor, and a second end electrically connected the second end of the first resistor and the gate end of the P-type thyristor.
